(19) United States
(12) Patent Application Publication
(10) Pub. No.: US 2004/0202863 A1
(43) Pub. Date: Oct. 14, 2004

(54) Coating method, coated product and ink jet recording medium

(75) Inventors: Atsushi Saito, Tokyo (JP); Yuichiro Maehara, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/371,364

(22) Filed: Feb. 20, 2003

(30) Foreign Application Priority Data
Feb. 26, 2002 (JP) JP2002-049715

(51) Int. Cl. B41M 5/00; B05D 1/02

(52) U.S. Cl. 428/411.1; 427/348

(57) ABSTRACT

A coating method comprising the steps of: forming liquid droplets of a liquid coating composition across a coating width in a direction perpendicular to a conveyance direction of a substrate to be coated; and spraying the liquid droplets formed toward the substrate while conveying the substrate, thereby coating the liquid coating composition onto the substrate.

### BACKGROUND OF THE INVENTION

The present invention relates to a coating method in which coating is carried out by spraying a liquid coating composition to form liquid droplets, to a coated product which is produced employing the same, and to an ink jet recording medium.

Heretofore, various methods have been known which apply a liquid coating composition onto a substrate. For example, Edward Cohen and Edgar Gutoff in “Modern Coating and Drying Technology”, describe various methods in which a liquid coating composition is accurately applied onto a long belt-shaped substrate (hereinafter occasionally referred to simply as a substrate). For example, known are a dip coating method, a blade coating method, an air knife coating method, a wire bar coating method, a gravure coating method, a reverse coating method, an extrusion coating method, a slide bead coating method, and a curtain coating method. Further, in these coating methods, in order to very accurately achieve a uniform dried layer thickness across the width of the substrate, coating is carried out while paying particular attention to accuracy and uniformity of coating thickness during the entire coating process (prior to as well as after coating).

Of these coating methods, particularly a coating apparatus, which includes flow rate specifying type dice, is capable of achieving high speed, thin layer, multilayer simultaneous coating. Due to these features, it is widely employed as a coating apparatus for light-sensitive photographic materials, ink jet recording materials, and magnetic recording materials.

Employed as one preferable example of the aforesaid coating apparatus is a slide bead coating apparatus, proposed in U.S. Pat. No. 2,761,791 by Russell et al. Alternatively, an extrusion coating apparatus is also widely employed. Further, a curtain coating apparatus, which is a flow rate specifying type apparatus including dice, is also widely employed.

For example, in the case of the aforesaid slide bead coating apparatus, a maintained liquid coating composition, called a bead, is formed between the leading end of the coating apparatus and the conveyed substrate, and coating is carried out via the bead. Further, in the case of the curtain coating apparatus, a curtain-shaped liquid coating composition layer is subjected to free-falling and coating is carried out while positioning a substrate at the falling position. These apparatuses are very useful to very accurately achieve a uniform dried layer thickness.

On the other hand, during coating employing such coating apparatuses including dice, the coating apparatus and the substrate are continuously in contact employing the liquid coating composition, due to this principle. In order to form a uniformly thick coating layer on the substrate, the flow rate of the liquid coating composition from the coating apparatus should always be constant and be continuously fed. Namely, in order to continuously form the coating layer, as well as to constantly maintain the coating layer thickness with high accuracy, a liquid coating composition amount more than the specified is required. Accordingly, in these systems, when the amount of the liquid coating composition discharged from the coating apparatus is excessively reduced, it becomes difficult to achieve the purpose for obtaining uniform layer thickness.

Due to that, when the amount of solutes per coating layer is small, namely when a layer is excessively thin (for example, about 1 to about 50 μm), prior to drying the coating layer, it becomes necessary to increase the total amount of the liquid coating composition by increasing the amount of solvents in the aforesaid liquid coating composition. Specifically, when the viscosity of the liquid coating composition is low, the coating layer flows on the substrate. As a result, it is difficult to form a stable coating layer and it is necessary to further increase the amount of the liquid coating composition.

However, when the solvent amount increases, load (drying load) to dry a coating layer through solvent evaporation increases. Such an increase is not preferable from the viewpoint of production efficiency. Further, when another composition layer is provided under the aforesaid coating layer, an excessive solvent amount or excessively long drying time occasionally results in adverse effects due to excessive penetration and diffusion of the liquid coating composition of the aforesaid coating layer into the aforesaid composition layer.

Therefore, a coating method has been demanded in which a thin layer is provided while enhancing accuracy of coating thickness, decreasing drying load, and increasing productivity.

Various coating products are known in which it is necessary to very accurately provide such a thin layer having a uniform coating thickness onto the composition layer. Listed as examples are void type recording media for ink jet printing.

Recording media applied to ink jet recording methods include those in which an ink absorptive layer itself is composed of paper such as plain paper, an ink absorptive layer is applied onto a support such as coated paper which functions as an absorbent, or an ink absorptive layer is applied onto a non-absorptive support such as resin coated paper or polyester film.

Of these, since surface smoothness of the support is enhanced and undulations are minimized, the recording medium, which is prepared by applying an ink absorptive layer onto a non-absorptive support, is preferably employed to produce output which is required to result in a high quality feel that is analogous to the gloss, luster and depth of silver halide photography. In addition, employed as glossy recording media which exhibit the high feel of gloss as well as feel of luster are swelling type recording media in which water soluble binders, such as polyvinylpyrrolidone and polyvinyl alcohol, are applied onto a non-absorptive support so as to form an ink absorptive layer and a so-called void type recording medium in which minute voids are formed as an ink absorptive layer, employing pigments or pigments together with binders so that ink is absorbed into the resulting voids.

In the void type recording media, the porous ink absorptive layer including the aforesaid voids is formed employing mainly hydrophilic binders and minute particles. Known as such minute particles are minute inorganic or organic particles. Commonly, minute inorganic particles, which produce high glossiness due to their small size, are employed. Further, by employing hydrophilic binders in a relatively small amount, compared to the aforesaid minute particles, voids are formed among minute particles whereby a porous ink absorptive layer is obtained.

Generally, various characteristics are demanded for the aforesaid porous ink absorptive layer. In order to enhance the various characteristics, use of the various additives, described below, has been proposed.

Listed as additives are:

1) Minute stable particles which form porous materials having a size of approximately 1 μm or less to achieve excellent color forming properties as well as high glossiness;

2). Hydrophilic binders which exhibit high minute particle holding capability, as well as low swellability, so that the ink absorption rate does not decrease;

3) Cross-linking agents of hydrophilic binders, which are used to enhance the ink absorption rate, as well as waterfastness, of the resulting layers;

4) Surfactant and hydrophilic polymers distributed over the entire surface to achieve an optimal dot diameter;

5) Cationic fixing agents to minimize dye bleeding as well as to enhance waterfastness;

6) Anti-discoloring agents to minimize discoloration of dye images due to ambient light and oxidizing gases;

7) Optical brightening agents and image tone control agents (reddening agents and bluing agents) to improve white backgrounds;

8) Matting agents and slipping agents to improve surface slip properties;

9) Various types of oil components, latex particles, or water-soluble plasticizers which provide flexibility to the porous ink absorptive layer;

10) Various inorganic salts (polyvalent metal salts) to minimize dye bleeding, and to enhance waterfastness as well as weather resistance; and

11) Acids and alkalis to adjust the surface pH of the porous ink absorptive layer.

However, when various additives, employed to achieve the aforesaid various purposes, are added to a liquid coating composition to form the porous ink absorptive layer, many additives are often subjected to various restrictions from the viewpoint of stability of the production processes.

Listed as such problems are, for example:

A) Due to coagulation of minute particles and each of the additives and phase separation in a liquid coating composition, it becomes difficult to carry out stable coating without mottling, gloss decreases to result in matte surface, and production efficiency markedly decreases due to a decrease in pot-life.

B) When a prepared liquid coating composition is allowed to stand over an extended period of time, viscosity of the liquid coating composition markedly increases to the point of gelling, or the viscosity markedly decreases, whereby the coating solution tends to flow on the substrata. As a result, it becomes difficult to carry out stable coating and it becomes difficult to obtain a uniform coating layer.

C) Surface cracks increase during coating and drying a porous ink absorptive layer.

D) The void ratio of the porous ink absorptive layer decreases.

Problems which relate to A) and B) often occur mainly due to electric interaction of the additives. For example, cationic fixing agents react with various raw materials having an anionic group, resulting in various problems.

Considered as one of the methods to overcome the aforesaid problems is a method in which a so-called overcoating layer is provided as follows. A porous ink absorptive layer liquid coating composition, which does not incorporate the aforesaid additives, is initially applied onto a support as a composition layer. Thereafter, a liquid coating composition, which incorporates the aforesaid additives, is applied onto the aforesaid composition layer as an overcoating layer. The aforesaid additives incorporated in the overcoating layer coating composition suitably penetrate into the previously provided composition layer (for example, a porous ink absorptive layer). As a result, it is expected that the desired functions are achieved without the aforesaid problems. Namely, it is expected that these will work as functional compounds. Originally, the purpose was that the functional compounds were to be allowed to impregnate the porous ink absorptive layer. Accordingly, the overcoating layer itself may be very thin. Alternatively, the overcoating layer is preferably very thin.

However, when two layers consisting of a composition layer and an overcoating layer are provided employing two processes (or two lines) as described below, problems occur in which production costs markedly increase. Initially, the aforesaid composition layer is coated and subsequently dried. Thereafter, the resulting coating is temporarily wound onto a roll and the coating is rewound from the roll. Subsequently, the overcoating layer is applied onto the composition layer and then dried. Further, after forming the composition layer, when the resulting coating is allowed to stand for some time, problems with quality stability occur due to temperature hysterisis as well as time fluctuation, and in addition, problems tend to occur in which coat mottling occurs during providing the overcoating layer.

Furthermore, it is common that coating of the aforesaid overcoating layer is carried out employing an extrusion coating method, a slide bead coating method, or a curtain coating method, using the flow rate specifying type die as previously described. However, when formation of a layer, requiring very uniform layer thickness, is carried out employing these coating methods, stable coating conditions should be established by increasing coating layer thickness or adding a large volume of solvents to the liquid coating composition.

As a result, a large volume of solvents (such as water and organic solvents) is provided on the surface of the ink absorptive layer due to coating of the overcoating layer, whereby it becomes inevitable that cost increases due to an increase in drying time or extension of the drying zone, while when drying capability is limited, coating speed is decreased. In addition, when a thick overcoating layer is applied, the degree of diffusion as well as penetration into the ink absorptive layer becomes greater until drying and a longer time is required for complete drying. As a result, effects are exhibited as if additives were directly incorporated into the porous ink layer coating composition. Due to that, it is impossible to sufficiently exhibit advantages of the overcoating layer.

### SUMMARY OF THE INVENTION

The present invention has been achieved to overcome the aforesaid problems. An object of the present invention is to provide a coating method which realizes high speed coating of a thin layer at a uniform layer thickness so as to result in lower drying load and coating products as well as ink jet recording media which are produced while coated employing the aforesaid coating method. Another object of the present invention is to provide a coating method in which when a thin layer is provided on a composition layer which has been formed through coating, the aforesaid composition layer is not adversely affected and total production efficiency is high. Still another object of the present invention is to provide a coating method in which specifically, during production of recording media for ink jet printing through coating, when a thin overcoating layer is provided on the composition layer employed as an ink absorptive layer, various desired characteristics of recording media, such as excellent coating layer uniformity, and high liquid coating composition stability are achieved.

The aforesaid problems of the present invention were overcome employing any one of Structures 1 through 24 described below.

Structure 1: A coating method wherein by conveying a substrate and spraying droplets across the coating width in the direction crossing the conveyance direction of the substrate, a liquid coating composition is applied onto the substrate.

Structure 2: The coating method, described in Structure 1 above, wherein variation of the average diameter of liquid droplets sprayed onto the substrate across the coating width is less than or equal to ±20 percent.

Structure 3: The coating method, described in Structure 1 or 2 above, wherein variation of the area range of the liquid droplet which is fallen onto the substrate across the coating width of the length in the conveyance direction is less than or equal to ±10 percent.

Structure 4: The coating method, described in any one of Structures 1 through 3 above, wherein variation of the spread angle of the liquid droplet which is fallen onto the substrate across the coating width is less than or equal to ±10 percent.

Structure 5: The coating method, described in any one of Structures 1 through 4 above, wherein variation of the space density of a group of liquid droplets which fall on the substrate across the coating width is less than or equal to ±10 percent.

Structure 6: The coating method, described in any one of Structures 1 through 5 above, wherein a slot nozzle spray apparatus is employed which includes a plurality of liquid coating composition nozzles, which discharge the liquid coating composition across the coating width, and also includes gas nozzles, which eject gas, adjacent to the opening end of the liquid coating composition nozzles which discharge the liquid coating composition, and the spraying is performed by forming liquid droplets while the gas is allowed to collide with the liquid coating composition.

Structure 7: The coating method, described in Structure 6 above, wherein a plurality of the slot nozzle spray apparatuses is provided in the conveyance direction of the substrate and spraying liquid droplets of the liquid coating composition is carried out at multiple stages.

Structure 8: The coating method, described in Structure 6 or 7 above, wherein the viscosity of the liquid coating composition is from 0.1 to 250 mPa·s.

Structure 9: The coating method, described in Structure 8 above, wherein the viscosity of the liquid coating composition is from 0.1 to 50 mPa·s.

Structure 10: The coating method, described in Structure 9 above, wherein the viscosity of the liquid coating composition is from 0.1 to 20 mPa·s.

Structure 11: The coating method, described in any one of Structures 1 through 10 above, wherein the solvent of the liquid coating composition is either water or a mixed solution comprising a water-compatible organic solvent and water.

Structure 12: The coating method, described in any one of Structures 1 through 11, wherein the wet layer thickness of the liquid coating composition is from 1 to 50 μm.

Structure 13: The coating method, described in any one of Structures 1 through 12 above, wherein the coating speed of the coating layer is from 50 to 300 m/minute.

Structure 14: The coating method, described in any one of Structures 1 through 13 above, wherein the substrate comprises a support having thereon at least one composition layer.

Structure 15: The coating method, described in Structure 14 above, wherein the composition layer is applied onto the support, and thereafter, the liquid coating composition is sprayed onto the composition layer in the form of liquid droplets during and after decreasing drying rate of the composition layer.

Structure 16: The coating method, described in Structure 15 above, wherein the composition layer is applied onto the support, and thereafter, the liquid coating composition is sprayed onto the composition layer in the form of liquid droplets at and after the drying end point.

Structure 17: The coating method, described in Structure 15 or 16 above, wherein the liquid coating composition comprises a functional compound for the composition layer.

Structure 18: The coating method, described in Structure 17 above, wherein a liquid coating composition, which is sprayed in the form of the liquid droplets, is the uppermost layer coating composition for ink jet recording paper.

Structure 19: The coating method, described in Structure 18 above, wherein the composition layer is an ink absorptive layer.

Structure 20: The coating method, described in any one of Structures 17 and 18 above, wherein the functional compound is selected from any of a surfactant, a hydrophilic binder cross-linking agent, an image stabilizer, and a water-soluble polyvalent metal compound.

Structure 21: The coating method, described in Structure 20 above, wherein the solvent of the liquid coating compositions is either water or a mixed solution consisting of a water-compatible organic solvent and water.

Structure 22: The coating method, described in Structures 14 through 21 above, wherein the support is a support which is prepared by covering both sides of paper with a polyolefin resin.

Structure 23: A coating product which is produced while employing the coating method described in any one of Structures 1 through 17.

Structure 24: An ink jet recording medium which is produced while employing the coating method described in any one of Structures 1 through 22.

### BRIEF DESCRIPTION OF THE DRAWINGS

FIG. 1 is a schematic view describing the coating method of the present invention.

FIG. 2 is a schematic sectional view of a slot nozzle spray apparatus comprising a slot nozzle spray section.

FIG. 3 is a view showing a slot nozzle spray section, and formation of liquid droplets formed therein and their ejected state.

FIG. 4 is a schematic view in which a slot nozzle spray section is viewed from the liquid coating composition discharge section.

FIG. 5 is a schematic view of another structure in which a slot nozzle spray section is viewed from the liquid coating composition discharge side.

FIG. 6 is a perspective exploded view of a slot nozzle spray comprising a liquid coating composition discharge section analogous to that shown in FIG. 5.

FIG. 7 is a schematic view showing one example of a coating production line provided with slot nozzle spray apparatuses.

### DETAILED DESCRIPTION OF THE PREFERRED EMBODIMENT

The inventors of the present invention performed diligent investigations to overcome the aforesaid problems and discovered the following: Instead of forming a continuous liquid coating composition layer, employing a coating apparatus including a flow rate regulating type die, which was conventionally employed, it became possible to achieve high speed thin layer coating, having uniform layer thickness and resulting in reduced drying load by forming liquid droplets of a liquid coating composition across the coating width in the direction which crosses the conveyance direction of the substrate and discontinuously supplying the liquid coating composition onto a substrate.

Herein, the substrate, as described in the present invention, refers to an object to be coated while employing the coating method of the present invention in which coating is carried out by spraying liquid droplets of a liquid coating composition, and its structure is not particularly limited. The aforesaid long belt shaped supports as well as those including the aforesaid support having thereon a composition layer are preferred because it is possible to efficiently exhibit the effects of the present invention. However, the aforesaid substrates are not limited to those. The substrates may include discrete flat board-shaped supports as well as non-flat shaped supports, and those in which portions to be coated have an area.

Further, in the present invention, the substrate is allowed to move (be conveyed) relative to the liquid coating composition discharge section of a coating apparatus, whereby continuous coating production is performed. The liquid coating composition discharge section of the coating apparatus has a width which is greater or equal to the coating width (which refers to the length of the coating portion of a substrate in the direction crossing the conveyance direction of the aforesaid substrate) of the substrate, and is arranged to cross the substrate so that the liquid coating composition is applied onto the substrate only by conveying the substrate with respect to the coating apparatus. When the substrate is a long belt-shaped support, it is preferable that the aforesaid belt-shaped support itself is allowed to be conveyed in the longitudinal direction thereof and the liquid coating composition discharge section is positioned across the width (the direction perpendicular to the longitudinal direction) of the aforesaid belt-shaped support. By conveying the substrate in one direction with respect to the coating apparatus and spraying the liquid coating composition across the coating width in the form of liquid droplets, it is possible to coat a very thin layer having a desired layer thickness, resulting in minimized drying load.

Further, across the coating width, liquid droplets, which are sprayed from the liquid coating composition discharge section of the coating apparatus, are required to satisfy the following conditions:

1. The liquid droplet diameter distribution is uniform;

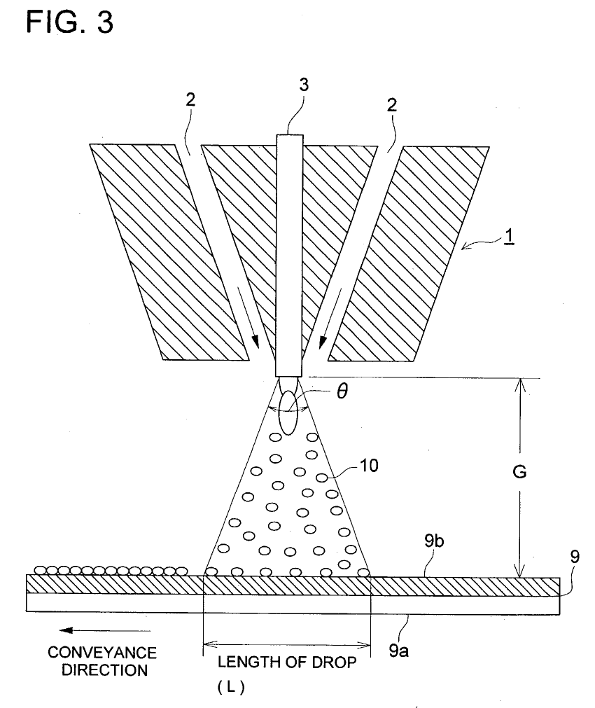

2. The length of drop (L shown in FIG. 3) in the conveyance direction of the area region, on which liquid droplets fall, is uniform;

3: The falling angle (θ shown in FIG. 3) onto the substrate is uniform; and

4: The collision rate is uniform of liquid droplets fallen on the substrate.

Upon satisfying the aforesaid conditions, it becomes possible to assure further uniformity of the coating thickness.

The uniform droplet diameter across the coating width direction, as described herein, specifically refers to variation of the average liquid droplet diameter of less than or equal to ±20 percent and preferably less than or equal to ±10 percent.

It is possible to calculate the variation of the average liquid droplet diameter, employing a laser diffraction type particle size distribution measurement apparatus. The measurement method, described below, is specifically used.

First, liquid coating composition is sprayed employing a spray apparatus such as a slot nozzle spray apparatus which sprays the aforesaid liquid coating composition in the form of liquid droplets and the state of the resulting spray is stabilized. Immediately after initiating spraying, the resulting spray state is not stabilized due to variation of the discharge volume of the liquid coating composition as well as variation of gas pressure. However, it is possible to achieve stabilization while continuing spraying after a specified time.

Subsequently, Spraytech RTS5123 (manufactured by Malvern Inc.) is employed as a laser diffraction type particle size distribution measurement apparatus to measure a group of liquid droplets in which the spray state has been stabilized. Across the coating width, the average liquid droplet diameter is measured at five positions located at regular intervals. At both edges (coating edges) across the coating width of a group of liquid droplets which fall on the substrate, the concentration of sprayed liquid droplets extremely decreases, whereby both edges are not included in the affective coating width. Accordingly, measurement points at both edges of the effective coating width are determined as two points at both edges. Specifically, a point which is located at 1 cm interior from the edge is used as a measurement point and two such points of both edges are used. Total five points, including three points in the interior which are positioned at regular intervals are employed as measurement points. Subsequently, a coefficient of variation is calculated, based on the average droplet diameter measured at the aforesaid five points.

Incidentally, it is possible to easily measure the average liquid droplet diameter, employing Sprayteck RTS5123. The diameter of individual droplets of a group of such liquid droplets is measured at the aforesaid measurement positions. Subsequently, when an integration plot is carried out while plotting the resulting liquid droplet diameter as the abscissa, the average droplet diameter refers to the liquid droplet diameter which locates at 50 percent by weight.

Further, “the length in the conveyance direction of the area range in which liquid droplets fall is uniform” means that variation of the aforesaid length across the coating width is less than or equal to ±10 percent, and preferably less than or equal to ±5 percent.

Incidentally, it is possible to measure variation of the length in the conveyance direction in the area range of liquid droplets which fall on the substrate by visualizing the liquid portion of a liquid droplet which comes into contact with the substrate.

Specifically, measurement is carried out employing the measurement method described below.

First, in the same manner as the aforesaid variation measurement method of the liquid droplet diameter, a liquid coating composition is sprayed employing a spray apparatus which sprays the liquid coating composition in the form of liquid droplets and the resulting spray state is stabilized.

Subsequently, appearance of spray, which is viewed in the coating width direction, is photographed at five positions located at regular intervals. Five positions, at which the appearance is photographed, are defined as described above. Thus, five images of spray are captured which are in the form of a semi-triangle which extends toward the substrate from the liquid coating composition discharge section (the opening end of the liquid coating composition nozzle) as a starting point. The base length of each triangle, that is the length of the liquid in contact with the substrate, is the length (length of drop L shown in FIG. 3) in the conveyance direction of the area range of liquid droplets which fall on the substrate. Variations are calculated based on the aforesaid length in the conveyance direction which is measured employing images captured at five positions.

Incidentally, when images are captured at each measurement position, by allowing a 1 mm slit light to be incident to sprayed liquid droplets from the direction (the conveyance direction of the substrate) perpendicular to the coating width direction, the aforesaid triangle in the measurement position is clearly visualized, whereby it is possible to capture the desired images.

Further, “the spreading angle of liquid droplets which fall onto the substrate is uniform” means that variation of the falling angle (θ shown in FIG. 3) of the liquid droplets which fall on the substrate is less than or equal to ±10 percent and is preferably less than or equal to ±5 percent.

It is possible to measure and calculate the variation of the spreading angle of the liquid droplet by visualizing the liquid coating composition discharge section of the coating apparatus. A specific measurement method follows. Being subject to the measurement method of the variation of the length in the conveyance direction in the area range of the liquid droplets which fall on the aforesaid substrate, each of the spreading angles is measured in the same manner, employing five images and subsequently the variation is calculated.

Further, “the space density of a group of liquid droplets which fall on the substrate is uniform” means that the variation of the space density of a group of liquid droplets, which fall on the substrate, is less than or equal to ±10 percent and is preferably less than or equal to ±5 percent.

Employing the transmission density of a laser beam, it is possible to measure the variation of the space density of a group of liquid droplets.

The specific method is subject to the aforesaid measurement method of the variation of the diameter of liquid droplets. As noted above, by employing Spraytech RTS5123, non-transmittance of a laser beam on a group of sprayed liquid droplets is measured at five positions located at regular intervals across the coating width. Herein, the non-transmittance is treated as space density of a group of liquid droplets.

In order to achieve uniform spray, as described above, a means is listed in which a so-called slot nozzle spray apparatus is used. The slot nozzle spray apparatus, as described herein, refers to an apparatus which comprises a plurality of liquid coating composition nozzles which discharge a liquid coating composition across the coating width. The slot nozzle spray apparatus has the mechanism described below. The nozzle openings for each liquid coating composition may be in a line or as a zigzag. In addition, a gas nozzle opening is provided adjacent to the aforesaid liquid coating composition nozzle opening and gas ejected from the aforesaid gas nozzle opening is allowed to collide with the liquid coating composition discharged from the aforesaid liquid coating composition nozzle opening so as to form liquid droplets.

Employed as a slot nozzle spray apparatus which can preferably be employed in the present invention is one described in Japanese Patent Application Open to Public Inspection No. H6-170308. The aforesaid patent discloses an example in which adhesive of disposable diapers is applied onto fiber and a highly viscous liquid coating composition (an adhesive) is fallen down in the form of a thread from a liquid coating composition nozzle (being a liquid coating composition discharge section) of a slot nozzle spray apparatus so that the coating apparatus and the substrate (fiber) are connected by the liquid coating composition in the form of a thread. Accordingly, in the aforesaid invention, discontinuous droplets which are employed in the present invention are not placed onto the substrate. The liquid coating composition in the form of a thread which falls in parallel to each other from each of a plurality of liquid coating composition nozzles which are provided across the coating width is disturbed by gas ejected from the gas nozzle provided adjacent to the aforesaid liquid coating composition nozzle and is hindered from its vertical fall, resulting in only random impinging in a certain area range on the substrate. In the absence of the gas nozzle, the liquid coating composition in the form of a thread vertically falls down without any modification. However, ejecting gas from the gas nozzle enables scattering of the liquid coating composition across a wider range and impinging the resulting liquid coating composition. However, the resulting coating layer is shaped as if thin noodles are spread. Accordingly, the resulting coating is not one in which strict uniformity of coating layer thickness is required for the entire surface of the substrate, as described in the example of the ink jet recording sheets. In addition, since adhesives are coated, the resulting coating layer is excessively thick.

Further, in the present invention, it is possible to preferably employ a slot nozzle spray apparatus disclosed in Japanese Patent Application Open to Public Inspection No. H5-309310. An example disclosed in Japanese Patent Application Open to Public Inspection No. H5-309310 relates to coating of a hot-melt type adhesive onto a substrate in the same manner as aforesaid Japanese Patent Application Open to Public Inspection No. H6-170308. Since an excessively viscous liquid coating composition (being an adhesive) is also employed, a similar method is used in which a liquid coating composition is continuously discharged onto a substrate surface in the form of a thread. As a result, the resulting layer thickness is not uniform and the resulting coating layer is excessively thick.

When such slot nozzle spray apparatuses are employed, it is possible to enhance uniformity of the spray state across the coating width, as noted above, by employing methods in which the viscosity of the liquid coating composition is adjusted to a relatively low level or the pressure of gas ejected from a gas nozzle is increased. Further, it is also possible to enhance uniformity of the aforesaid spray by decreasing the area of the nozzle opening of the liquid coating composition of the slot nozzle spray apparatus as well as by decreasing the pitch of the aforesaid opening.

The viscosity of liquid coating compositions is preferably from 0.1 to 250 Pa·s, is more preferably from 0.1 to 50 Pa·s, and is still more preferably from 0.1 to 20 Pa·s. By supplying such a low viscous liquid coating compositions to the slot nozzle spray apparatus, it is possible to achieve a spray of uniform liquid droplets across the coating width.

Further, in order to achieve a spray of uniform liquid droplets across the coating width, the surface tension of liquid coating compositions is adjusted from 20 to 70 mN/m, preferably from 20 to 50 mN/m, and more preferably from 20 to 30 mN/m.

Still further, when liquid droplets are formed by allowing gas to collide with the liquid coating composition while employing slot nozzle spray apparatuses, a uniform spray is easily achieved by employing gas having an inner gas pressure of at least 10 kPa, more preferably at least 20 kPa, and still more preferably at least 50 kPa. The flow rate of gas is commonly at least 3.5 CMM/m, is preferably at least 7 CMM/cm, and is more preferably at least 10 CMM/m.

When employing the aforesaid means, a liquid coating composition is scattered in the form of discontinuous liquid droplets across the coating width instead of forming the threads, whereby it is possible to uniformly apply the liquid coating composition onto the substrate, even though the amount of the liquid coating composition is small. As a result, it is possible to make the coating thickness uniform. Further, due to the supply of discontinuous liquid droplets onto the substrate, the amount of the liquid coating composition can be decreased resulting in a minimal load.

The structure of the slot nozzle spray coating apparatus is not particularly limited, but one preferable example is shown below.

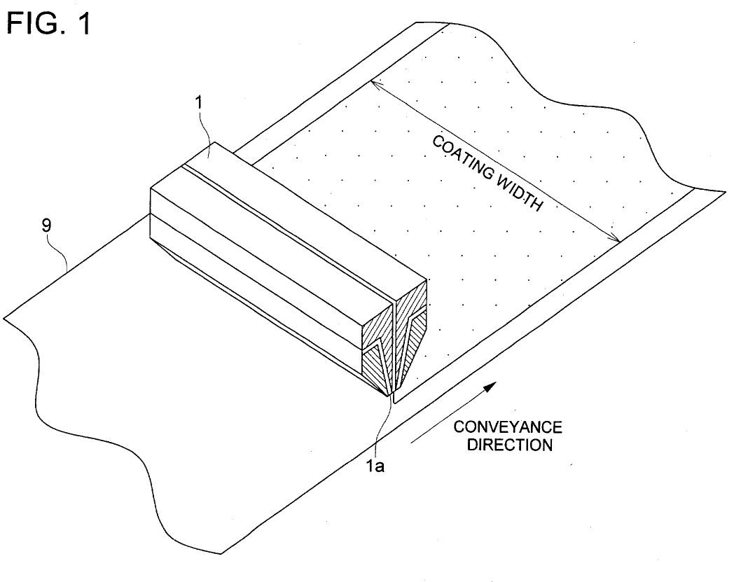

FIG. 1 is a schematic view describing the coating method of the present invention. In FIG. 1, reference numeral 1 is the slot nozzle spray section of the slot nozzle spray apparatus (the entire apparatus is not shown), 9 is a lengthy belt-shaped support type substrate. Substrate 9 is conveyed at a constant rate, employing a conveyance means (not shown). Liquid coating composition discharge section 1a of slot nozzle spray section 1 has its length across the width of substrate 9 which is perpendicular to the conveyance direction and is arranged so as to face the coating surface of substrate 9. The liquid coating composition is sprayed in the form of liquid droplets and coating is carried out so that the resulting droplets impinge on conveyed substrate 9. In such a case, the liquid coating composition adhesion length across the width of substrate 9 corresponds to the coating width shown by the arrow in FIG. 1. In FIG. 1, though the coating width is less than the length across the width of substrate 9, the same length may be allowed.

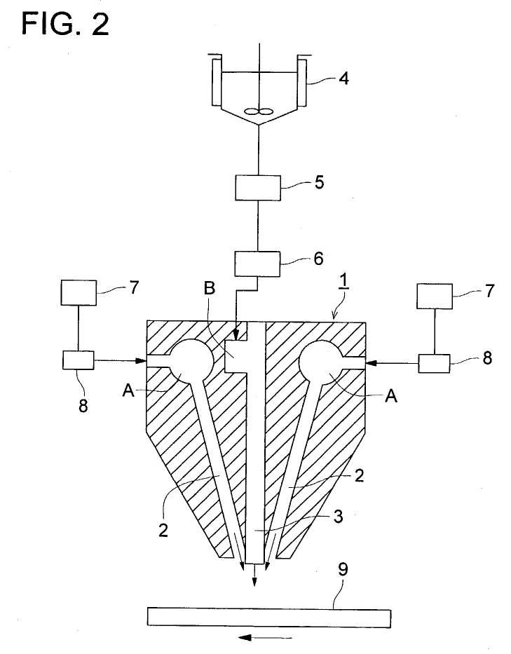

FIG. 2 is a schematic sectional view of a slot nozzle spray apparatus comprising slot nozzle spray section 1.

In FIG. 2, slot nozzle spray section 1 comprises a pair of gas nozzles 2, having gas pocket A, and liquid coating composition nozzle 3, having liquid coating composition pocket B. A liquid coating composition such as a solution comprising compounds, for example, a functional compound containing compounds, having a viscosity (preferably from 0.1 to 250 mPa·s), capable of forming liquid droplets without forming threads is fed into preparation tank 4, and subsequently is supplied to liquid coating composition pocket B via pump 5 and flow meter 6, and is subsequently led to liquid coating composition nozzle 3. On the other hand, pressurized air is supplied to pocket A via valve 8 from pressurized air source 7. During coating, the liquid coating composition is supplied from preparation tank 4 so that the specified coating amount is discharged from liquid coating composition nozzle 3. Simultaneously, pressurized air is ejected from a pair of gas nozzles, whereby the liquid coating composition is shaped into liquid droplets which are sprayed onto substrate 9 to be impinged. In the coating method of the present invention, one feature is that it is possible to spray the liquid coating composition in the form of minute liquid droplets instead in the form of threads. By impinging the liquid coating composition onto the surface of substrate 9 in the form of minute liquid droplets, it is possible to form, at high seed, a thin layer having markedly high uniformity, while minimizing drying load.

With reference to FIG. 3, described will be slot nozzle spray section 1, as well as the shape of liquid droplets formed therein and the ejected state of liquid droplets.

In FIG. 3, the liquid coating composition, which is discharged from liquid coating composition nozzle 3, is finely divided to form liquid particles, employing compressed air supplied from gas nozzle 2 which is installed adjacent to both sides of liquid coating composition nozzle 3, whereby semi-spherical liquid droplets 10 are formed, which subsequently impinge uniformly on the surface of substrate 9 that is provided at spaced gap (G) from liquid coating composition nozzle 3. FIG. 3 shows a model in which substrate 9 comprises support 9a having thereon an ink absorptive layer as a composition layer. It is preferable that the area range of liquid droplets of the liquid coating composition, which impinge on substrate 9, remains uniform. It is also particularly preferable that the length in the conveyance direction (described as length of drop (L) in FIG. 3) remains uniform across the coating width. Further, it is preferable that spreading angle θ of a group of liquid droplets which are sprayed toward the substrate from the opening of liquid coating composition nozzle 3 is uniform across the coating width.

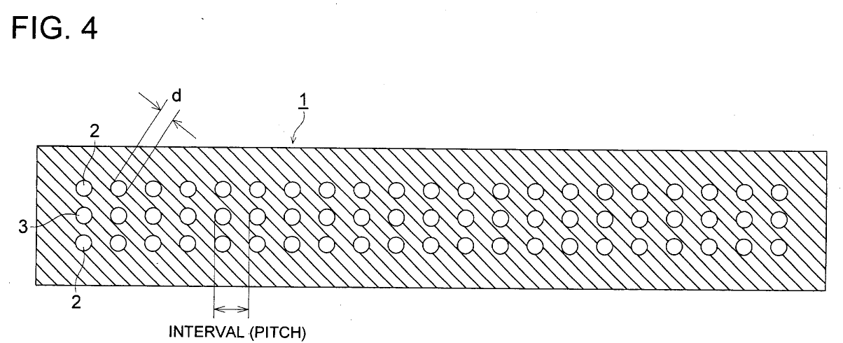

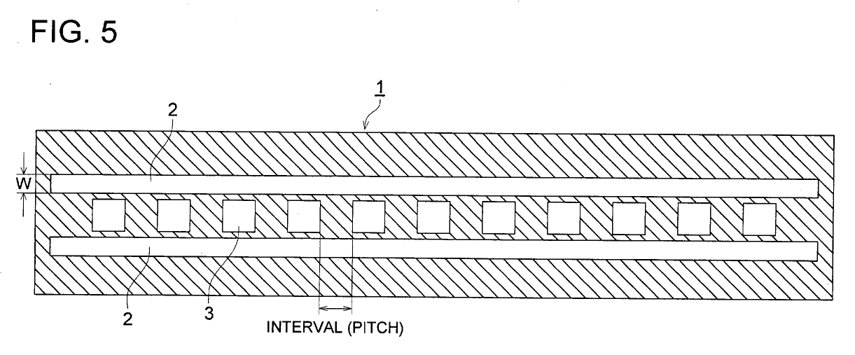

FIGS. 4 and 5 are schematic views in which slot nozzle spray section 1 in FIG. 3 is viewed from the side of coating liquid discharge section 1a, and show the opening end of a plurality of liquid coating composition nozzles 3 arranged across the coating width as well as the opening of gas nozzle 2.

In the liquid coating composition discharge section shown in FIG. 4, twenty-one of liquid coating composition nozzles 3, having a circular end opening, are aligned across the coating width. Further, the embodiment is that gas nozzle 2 is installed adjacent to both sides of the opening end of each liquid coating composition nozzle 3. Liquid coating composition nozzles 3 are arranged at equally spaced intervals. In FIG. 4, two gas nozzles 2 paired with one liquid coating composition nozzle 3 is aligned in the direction perpendicular to the coating width. However, liquid coating composition nozzles 3 and gas nozzles 2 may be arranged in a zigzag pattern. It is preferable that the interval between openings of liquid coating composition nozzle 3 or gas nozzle 2 remains at equally spaced intervals.

The liquid coating composition discharge section shown in FIG. 5 is different from the one shown in FIG. 4. Eleven liquid coating composition nozzles 3, having a rectangular opening, are aligned across the coating width. Further, across the coating width, one slit-shaped gas nozzle 2 is arranged adjacent to each side of the opening with respect to each of all coating liquid nozzles 3. In such an embodiment, a plurality of rectangular openings of the liquid coating composition is arranged at equally spaced intervals.

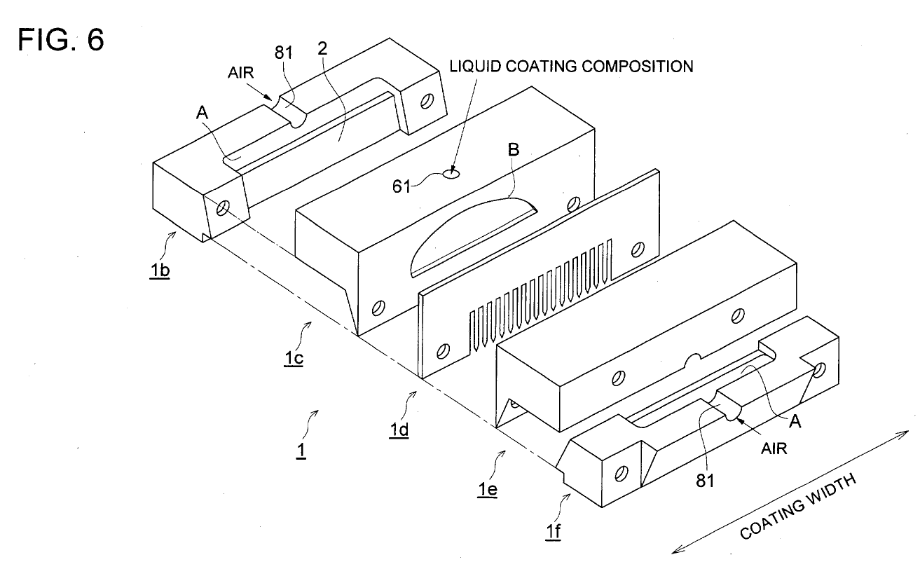

FIG. 6 is a perspective exploded view of slot nozzle spray section 1, comprising a liquid coating composition discharge section analogous to that shown in FIG. 5. In FIG. 6, reference symbols 1c and 1e are die blocks which form a coating slit at the specified distance, and allow the liquid coating composition to flow down the aforesaid slit. One die block 1c receives the liquid coating composition supplied from a coating liquid supply source (not shown) and comprises a liquid coating composition supply pipe which allows the liquid coating composition to pass into liquid coating composition pocket B. The liquid coating composition, which is retained in liquid coating composition pocket B, flows down employing the liquid coating composition slit formed between die blocks 1c and 1e. Symbol 1d is a shim (packing metal) interposed between block 1c and 1e. The slit for the liquid coating composition is divided in the perpendicular direction so as to form a plurality of liquid coating composition nozzles across the coating width.

Further, 1b and 1f each is a gas block and forms a gas nozzle in the gap of each of 1c and 1e, through which compressed gas passes. In such a case, the gas nozzle is a slit which extends across the coating width. Compressed air is supplied to air supply pipe 81 of each gas block, and after a temporary stay in liquid coating composition pocket B, pressurized downward flow results through the gas nozzle formed in the gap between the gas block and the die block.

The liquid coating composition, which flows down the space of aforesaid shim 1d and compressed air which has flown down two gas nozzles, are allowed to collide with each other in the coating liquid discharge section, which is the bottom section of slot nozzle spray 1, whereby liquid droplets are formed and impinge onto the substrate 9 which is to be coated.

In the slot nozzle spray apparatus employed in the present invention, the shape of the opening end of liquid coating composition nozzle 3 may be either circular or rectangular. The usable size is in the range of 50 to 300 μm. Each pitch (interval) of them is preferably from 100 to 3,000 μm. On the other hand, the shape of the opening end of the gas nozzle may be either circular or slit-shaped, and extend across the coating width. In such cases, a usable circle diameter (d shown in FIG. 4) or slit interval (W shown in FIG. 5) is about 50 to 500 μm. The angle of the gas nozzle with respect to the liquid coating composition nozzle is preferably in the range of 5 to 50 degrees. Further, it is possible to appropriately select the distance (G shown in FIG. 3) between the liquid coating composition discharge section of the slot nozzle spray section and the substrate to be in the range of about 2 to about 50 mm.

The supply rate of the liquid coating composition from the liquid coating composition nozzle is optional, since it varies depending on the desired coating layer thickness, the concentration of liquid coating composition, the coating speed, and the like. However, the coating amount on the substrate is preferably in the range of about 1 to about 50 g/m². When the coating amount is less than 1 g/m², it is difficult to form a stable uniform coating layer, while when it exceeds 50 g/m², it becomes difficult to exhibit the desired effects of the present invention. It is characteristic that the wet layer thickness of the liquid coating composition is from 1 to 50 μm, and is preferably from 5 to 30 μm.

On the other hand, gases to be ejected from the gas nozzle are not particularly limited as long as they are suitable for coating, and common air is usually employed. Gas supply conditions are preferably in the range of about 1 to about 50 CMM/m. In such cases, from the viewpoint of achieving uniform coating, inner pressure in the gas nozzle is preferably at least 10 kPa.

From the viewpoint of being capable of effectively achieving the purposes of the present invention, the air flow velocity is preferably from 126 to 400 m/s. Specifically, the lower limit is preferred from the viewpoint of coating and drying properties, while the upper limit is preferred from the viewpoint of a drying yield. The “air flow velocity”, as described herein, refers to the air flow velocity immediately after the exit of the gas nozzle, which is determined employing a laser Doppler anemometer such as 1D FLV System 8851, produced by KANOMAX Inc. Further, the “coating yield”, as described herein, refers to a numerical expression of (the amount of the liquid coating composition applied onto a recording medium divided by the amount of the total supplied liquid coating composition×100 (in percent)), which is calculated employing a gravimetric method. Namely, the amount of the liquid coating composition applied to the recording medium is calculated based on the weight difference prior to and after applying onto the coating medium, while the amount of the total supplied liquid coating composition is calculated based on the weight of the liquid coating composition which is conveyed and supplied to the liquid coating composition discharge section, i.e. an expression of (the flow rate of the liquid coating composition×coating time). Further, in such cases, from the viewpoint of being capable of effectively achieving the purposes of the present invention, the average diameter of liquid droplets of the liquid coating composition is preferably from 10 to 70 μm. The “average diameter of droplets of liquid coating compositions”, as described herein, refers to the average droplet diameter in the position of the coating gap (the distance between the liquid coating composition discharge section and the recording medium, that is, G shown in FIG. 3), which is measured employing a laser diffraction type particle size measurement apparatus.

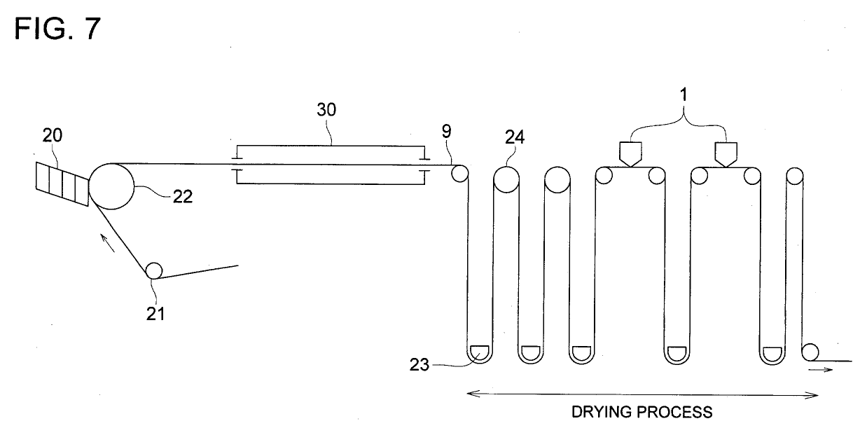

FIG. 7 shows one example of a coating production line provided with a slot nozzle spray apparatus as above. In FIG. 7, a substrate is employed which comprises a support coated with a composition layer. After coating the aforesaid composition layer, a plurality of slot nozzle spray apparatus (in a multistage format) is arranged in the drying process. Herein, forming the composition layer, as well as coating the overcoating layer (being the uppermost layer) according to the present invention in a single line, as stated above, is called “on-line coating”.

A support from a master roll is allowed to pass over conveyance roller 21, employing a conveyance means (not shown). Subsequently, during the process in which the support is subjected to reverse conveyance in the position of back-up roller 22, a porous ink absorptive layer (being a composition layer) coating composition, which is supplied from a flow rate regulating type slide bead coating apparatus 20, is coated. Since the porous ink absorptive layer coating composition comprises hydrophilic binders, the resulting coating is temporarily cooled and set in cooling zone 30. Substrate 9, which comprises the resulting support having thereon the composition layer, is conveyed to a drying process. In the drying process, there are alternately arranged reverser 23 which blows air and achieves reverse conveyance in no contact with the coating layer surface, and an ordinary conveyance roller 24 which performs reverse conveyance in contact with the back surface, whereby substrate 9 is subjected to meandering conveyance. In the aforesaid process, drying is carried out while blowing warm air (the warm air blowing means is not shown). On the way of the aforesaid drying process, preferably after decreasing drying rate, coating is carried out through liquid droplet spraying, as described in the present invention, employing two slot nozzle spray apparatuses 1. It is preferable that at least one of two slot nozzle spray apparatuses is arranged at and after the drying end point, from the viewpoint of drying properties. Herein, two slot nozzle spray apparatuses are employed. However, the number of the apparatus may be only 1 or 3 or more. It has been discovered that when coating employing liquid droplet spray is performed under multistage system, drying load decreases and simultaneously, uniformity of the layer thickness is enhanced.

When a thin layer is formed on the substrate, employing the coating method of the present invention, the coating speed may not be necessarily specified, since it varies depending on the types of liquid coating compositions, the concentration, the content of solvents, and the drying capacity. However, the coating speed is preferably from 50 to 300 m/minute, with more preferred coating speed being from 100 to 300 m/minute.

In the coating method of the present invention, when a layer is applied onto a substrate comprising a support having thereon at least one composition layer, the subsequent coating is preferably carried out at and after the initiation of the decreasing drying rate of the composition layer formed on the support, and is more preferably carried out at and after the drying end point. Further, it is preferable that a coating process in which the aforesaid composition layer is coated, employing slide bead coating, and a coating process in which coating is carried out employing the slot nozzle spray apparatus of the present invention are continuously performed employing a single production line (called on-line coating). The coating method according to the present invention is capable of carrying out effective coating, even though the amount of the liquid coating composition is relatively small. As a result, even though coating is carried out before the aforesaid composition layer is not completely dried, drying load is relatively low and the aforesaid composition layer is not adversely affected. Further, it was discovered that it was actually possible to minimize drawbacks such as cracking of the aforesaid composition layer.

Due to the relatively small drying load, it is possible to apply the coating method of the present invention in the drying process of the aforesaid composition layer. Generally, in a drying process, drying is carried out by blowing drying air, conditioned to a specified temperature and humidity, onto the surface or the back of the support, while continuously conveying a wet coating layer.

It is possible to classify the drying process of a wet coating layer, as described below. An initial drying section is called a constant-rate drying section, in which since solutes in the liquid coating composition, such as water and solvents, are evaporated while depriving latent heat of evaporation, the surface temperature of the composition layer remains almost constant. A section, in which temperature remains constant as above, is called a constant-rate drying section. Following the constant-rate drying section, water and solvents, which result in interaction with solutes of the liquid coating composition, are evaporated, whereby other than the latent heat of evaporation, energy is required to be free from interactions. As a result, the surface temperature increases. Such a section is called a decreasing drying rate section. The decreasing drying rate, as described herein, is a phenomenon which occurs when evaporation of solvents from the surface exceeds migration of water in the layer. When the decreasing drying rate ends, a region starts in which the temperature of drying air is equal to the surface temperature of the ink jet recording medium. The resulting point is called the drying end point.

Confirming methods of the constant rate drying section, the decreasing drying rate section, and the drying end point are not particularly limited. They may be determined as follows. For example, upon monitoring surface temperatures, the region in which the surface temperature is constant is designated as the constant-rate drying section, the region in which the surface temperature increases is designated as the decreasing drying rate section, and the point at which the surface temperature is the same as the drying temperature is designated as the drying end point.

Further, in another method, a water content meter is installed in each region and the water content of coating layers is monitored. The point at which the water content decrease curve flattens can be designated as the drying end point.

The viscosity of the liquid coating composition, employed in the coating method of the present invention, is preferably from 0.1 to 250 mPa·s, is more preferably from 0.1 to 50 mPa·s, and is still more preferably from 0.1 to 20 mPa·s.

The coating method of the present invention is capable of uniformly forming a thin layer and may be applied to a wide variety of manufacturing fields. For example, it may be applied to provide a functional layer onto the uppermost surface of common silver halide light-sensitive materials, formation of reflection inhibiting layers, and coating of charge generating layers and charge transport layers employed in electrophotography. Particularly, it is preferably applied to coating of an overcoating layer onto ink jet recording media.

Ink jet recording media, to which the coating method of the present invention is preferably applied, comprise a support having thereon a porous ink absorptive layer comprised of hydrophilic binders and minute particles as a composition layer. An overcoating layer is then applied onto the porous ink absorptive layer, employing the coating method of the present invention.

The porous ink absorptive layer is formed employing minute particles and hydrophilic binders as main components. Minute silica particles synthesized by a gas phase method are preferably employed as minute particles, while preferably employed as hydrophilic binders are polyvinyl alcohols.

Employed as supports which are used in such ink jet recording media may be water absorptive supports (such as paper) as well as non-water absorptive supports. From the viewpoint of ability of producing higher quality prints, non-water absorptive supports are preferable. Such supports include paper supports in which both sides of the paper are laminated with polyolefin resins.

A liquid coating composition for the aforesaid porous ink absorptive layer (for the composition layer), which is comprised of polyvinyl alcohol and minute silica particles, tends to exhibit low viscosity at relatively high temperature and high viscosity at relatively low temperature. Accordingly, after applying the aforesaid water-based liquid coating composition onto the support, it is preferable that the viscosity of the resulting liquid coating composition is markedly increased by cooling the aforesaid liquid coating composition.

The coating temperature of the porous ink absorptive layer is commonly from 30 to 60° C. Cooling temperature after coating may be controlled so that the temperature of the resulting coating layer is less than or equal to approximately 20° C. Specifically, it is preferable to control the temperature to be less than or equal to 15° C.

After coating, it is possible to cool the resulting coating upon passing it through a cooling process comprised of cooling zones, cooled at, for example, 15° C. or lower over a specified time (preferably at least 5 seconds). From the viewpoint of preparing a uniform coating layer without mottling while minimizing unevenness, it is preferable that it is not subjected to strong air flow during cooling.

After once cooling the coating layer, the viscosity of the liquid coating composition itself increases, and even though strong air flow is applied, it is possible to minimize the unevenness of the coating layer. Even though it is possible to blow air at 20° C. or higher, it is preferable that the temperature of air is increased gradually.

After applying the porous ink absorptive layer coating composition onto a support, the resulting coating is dried employing a drying process. In such drying process, the resulting coating is subjected to blown air and is allowed to pass through high temperature zones, or is subjected to both combinations.

When drying is carried out by passing the coating through high temperature zones, temperatures of the drying zones are from 50 to 150° C. In such cases, it is preferable to select a suitable drying temperature while taking into account the heat resistance of supports as well as adverse effects to coating layers. The relative humidity of the drying air is commonly from 10 to 50 percent, and is preferably from 15 to 40 percent. Drying time varies depending on the wet layer thickness, but is preferably at most 10 minutes, and is most preferably at most 5 minutes.

Coating speed varies depending on the wet layer thickness, facilities, and the drying capacity, but is commonly about 10 to about 1,000 m per minute, with 20 to 500 m per minute being preferred.

The aforesaid porous ink absorptive layer coating composition may be coated, employing a suitable method which is selected from methods known in the art. Preferably employed are, for example, a gravure coating method, a roll coating method, a rod bar coating method, an air knife coating method, an extrusion coating method, a curtain coating method, or an extrusion coating method described in U.S. Pat. No. 2,681,294, which employs a hopper.

An overcoating layer coating composition will now be described which is employed to provide the aforesaid overcoating layer onto the porous ink absorptive layer of ink jet recording media, employing the slot nozzle spray apparatus of the present invention.

The overcoating layer coating composition is characterized in comprising functional compounds which act on the surface of the composition layer of ink jet recording media.

There are listed organic or inorganic acids of which the pH varies by the use of the aforesaid functional compounds, various alkaline additives, water-soluble salts of water-soluble polyvalent metal ions, various anionic, cationic, amphoteric or nonionic surfactant, anti-discoloring agents, cationic fixing agents, or cross-linking agents of hydrophilic binders.

Listed as acids which can be used to decrease the surface pH of the porous ink absorptive layer may be, for example, inorganic acids such as sulfuric acid, hydrochloric acid, nitric acid, phosphoric acid, as well as organic acids such as citric acid, formic acid, acetic acid, phthalic acid, succinic acid, oxalic acid, and polyacrylic acid.

Listed as alkalis which are used to increase the surface pH of the porous ink absorptive layer may be, for example, sodium hydroxide, potassium hydroxide, sodium carbonate, potassium carbonate, borax, sodium phosphate, calcium hydroxide, and organic amines.

The aforesaid pH regulating agents are most preferably employed when the pH of the liquid coating composition used to produce porosity is different from the preferable pH of the recording media.

The surface pH of the porous ink absorptive layer of the recording media varies depending on the types of ink. Generally, at a lower pH, water resistance of dyes is enhanced and bleeding of dyes is minimized. On the other hand, at a higher pH, lightfastness of dyes tends to be markedly improved. Considering that, an optimal pH is selected based on combinations with the used ink. The pH of the porous surface is preferably from 3 to 7, and is more preferably from 3.5 to 6.5. The layer surface pH, as described herein, refers to the value determined based on Surface pH Measurement Method of Paper, specified in J. TAPPI 49. In practice, 50 μl of pure water (having a pH of 6.2 to 7.3) is dripped onto the surface of a recording medium and the resulting pH is measured, employing a commercially available flat electrode.

The aforesaid functional compounds may include surfactant.

Surfactant are capable of controlling dot diameter during ink jet recording. Listed as such surfactant may be anionic, cationic, amphoteric, and nonionic surfactant. Further, surfactant may be employed in combination of at least two types. The added amount of surfactant is about 0.01 to 50.00 mg per m² of the recording media. When exceeding 50 mg, unevenness in mottled appearance tends to occur during ink jet recording.

The aforesaid functional compounds may also include cross-linking agents of hydrophilic binders.

Employed as such cross-linking agents may be those known in the art, and include as preferable agents the aforesaid boric acids, zirconium salts, aluminum salts, or epoxy based cross-linking agents.

The aforesaid functional agents may be image stabilizers (hereinafter occasionally referred to as anti-discoloring agents). These anti-discoloring agents minimize color fading due to light irradiation, as well as various types of oxidizing gases such as ozone, active oxygen, NOₓ, and SOₓ.

Employed as the aforesaid functional compounds may be cationic polymers.

Generally, cationic polymers act as a fixing agent of dyes and enhance water resistance as well as minimize bleeding. Accordingly, it is preferable that the cationic polymers are previously incorporated in a liquid coating composition which forms a porous receptive layer. However, when problems occur due to the addition of cationic polymers to the liquid coating composition, it is possible to supply the cationic polymers, employing an overcoating method. For example, when the viscosity of a liquid coating composition increases during storage through incorporation of cationic polymers, or when coloring properties are improved by allowing forming the specified distribution of cationic polymers in the porous layer, it is preferable to supply the cationic polymers, employing the overcoating method. When the cationic polymers are supplied employing the overcoating method, the amount of cationic polymers is commonly in the range of 1 to 5 g per m² of the recording medium.

The aforesaid functional compounds may include water-soluble polyvalent metal compounds.

These water-soluble polyvalent metal compounds tend to coagulate in a liquid coating composition comprising minute inorganic particles, whereby minute coating defects, as well as a decrease in glossiness, tend to occur. Therefore, it is particularly preferable to supply the water-soluble polyvalent compounds, employing an overcoating method.

Employed as such polyvalent metal compounds are, for example, sulfates, chlorides, nitrates and acetates of Mg²⁺, Ca²⁺, Zn²⁺, Zr²⁺, Ni²⁺, or Al³⁺.

Each of the aforesaid functional agents may be employed individually or in combination of at least two types. Specifically, it is possible to employ an aqueous solution containing at least two anti-discoloring agents, a solution containing an anti-discoloring agent and a cross-linking agent, as well as a solution containing an anti-discoloring agent and a surfactant. In addition, it is possible to employ in combination cross-linking agents, water-soluble polyvalent compounds and anti-discoloring agents.

Employed as solvents of the aforesaid functional compounds may be water or solutions prepared by mixing water with water-compatible (or water-miscible) organic solvents, however it is particularly preferable to employ water. Further preferred are mixed solvents of water with water-compatible low boiling-point organic solvents (such as methanol, ethanol, i-propanol, n-propanol, acetone, and methyl ethyl ketone). When water and water-compatible organic solvents are employed in combination, it is preferable that the content ratio of water is at least 50 percent by weight under weight ratio.

Low boiling-point organic solvents, as described herein, refer to organic solvents which have a water solubility of at least 10 percent by weight at room temperature and have a boiling point of at most 120° C.

Further, from the viewpoint of obtaining uniform coatability, the surface tension of liquid coating compositions, which are employed in the coating method of the present invention, is preferably from 20 to 60 mN/m.

### EXAMPLES

The present invention will now be described with reference to examples in which the overcoating layer of ink jet recording media is provided employing the coating method of the present invention. However, the present invention is not limited to these examples.

### Example 1

(Preparation of Substrate)

A substrate was prepared in which a porous ink absorptive layer comprised of four layers was formed on a support as a composition layer.

At first, the composition layer coating composition, described below, was prepared. Employed as silica in the silica dispersion, described below, was gas phase method silica (Aerosil 200, manufactured by Nippon Aerosil Co.), having an average primary particle diameter of 0.012 μm. Further, the oil dispersion, described below, contained an antioxidant. Each added amount is per liter. In these examples, percent is percent by weight, unless otherwise specified.

<First Layer Coating Composition: Lowermost Layer>

| | |
|---|---|
| Silica dispersion | 580 ml |
| 10 percent aqueous polyvinyl alcohol | 5 ml |
| (PVA203, manufactured by Kuraray | |
| Co.) solution | |
| 6.5 percent aqueous polyvinyl alcohol | 290 ml |
| (having an average degree of | |
| polymerization of 3,800 and a | |
| saponification ratio of 88 | |
| percent) | |
| Oil dispersion | 30 ml |
| Latex dispersion (AE803, manufactured | 42 ml |
| by Showa Kobunshi Co.) | |
| Ethanol | 8.5 ml |
| Pure water to make | 1000 ml |

<Second Layer Coating Composition>

| | |
|---|---|
| Silica dispersion | 600 ml |
| 10 percent aqueous polyvinyl alcohol | 5 ml |
| (PVA203, manufactured by Kuraray | |
| Co.) solution | |
| 6.5 percent aqueous polyvinyl alcohol | 270 ml |
| (having an average degree of | |
| polymerization of 3,800 and a | |
| saponification ratio of 88 | |
| percent) | |
| Oil dispersion | 20 ml |
| Latex dispersion (AE803, manufactured | 22 ml |
| by Showa Kobunshi Co.) | |
| Ethanol | 8 ml |
| Pure water to make | 1000 ml |

<Third Layer Coating Composition>

| | |
|---|---|
| Silica dispersion | 630 ml |
| 10 percent aqueous polyvinyl alcohol | 5 ml |
| (PVA203, manufactured by Kuraray | |
| Co.) solution | |
| 6.5 percent aqueous polyvinyl alcohol | 270 ml |
| (having an average degree of | |
| polymerization of 3,800 and a | |
| saponification ratio of 88 | |
| percent) | |
| Oil dispersion | 10 ml |
| Latex dispersion (AE803, manufactured | 5 ml |
| by Showa Kobunshi Co.) | |
| Ethanol | 3 ml |
| Pure water to make | 1000 ml |

<Fourth Layer Coating Composition: Uppermost Layer>

| | |
|---|---|
| Silica dispersion | 660 ml |
| 10 percent aqueous polyvinyl alcohol | 5 ml |
| (PVA203, manufactured by Kuraray | |
| Co.) solution | |
| 6.5 percent aqueous polyvinyl alcohol | 250 ml |
| (having an average degree of | |
| polymerization of 3,800 and a | |
| saponification ratio of 88 | |
| percent) | |
| 4 percent aqueous betaine type surface | 3 ml |
| active agent | |
| 25 percent aqueous saponin solution | 2 ml |
| Ethanol | 3 ml |
| Pure water to make | 1000 ml |

Subsequently, a substrate was prepared by simultaneously applying each of the aforesaid liquid coating compositions at 40° C. onto a paper support laminated with polyethylene on both sides, employing a slide bead type coating apparatus so as to achieve the wet layer thickness described below.

<Wet Layer Thickness>

First layer: 42 μm

Second Layer: 39 μm

Third layer: 44 μm

Fourth layer: 38 μm

After applying an ink adsorptive layer coating composition, the resulting coating passed through a 5° C. cooling zone over 15 seconds so as to decrease the layer surface temperature to 13° C. Thereafter, the coating was dried by passing through each of the several zones of a drying process in which air at the temperature, described below, was successively blown over the surface of the ink absorptive layer.

Incidentally, the total time of the drying process was set at 360 seconds. Of these, for 270 seconds after the start of drying, the average relative humidity of the blown air was set at less than or equal to 30 percent. After 270 seconds, a rehumidifying zone, having a relative humidity of 40 to 60 percent was provided.

During drying, layer surface temperatures were measured. As a result, it was found that the constant-rate drying section continued for 270 seconds after the start of drying and thereafter, the decreasing drying rate section started, and the drying end point (the position in which the layer surface temperature was equal to the temperature of blown air) was located approximately 240 seconds after the start of drying.

(Coating Method 1)

Employed as an overcoating layer coating composition was a 4 percent boric acid solution. Viscosity and surface tension of the aforesaid liquid coating composition, at room temperature, were 1.5 mPa·s and 60 to 70 mN/m, respectively.

Prepared as a coating apparatus was the slot nozzle spray apparatus shown in FIGS. 2, 3, 5, and 6. In such a case, the opening end of the liquid coating composition nozzle was a 120 μm long rectangular, while the pitch was 1,000 μm. The gas nozzle was shaped to be a 200 μm wide slit. During operation, the inner gas pressure was set at 20 kpa, while the air flow rate was set at 12 CMM/m, and the distance between the liquid coating composition discharge section and the recording medium (G shown in FIG. 3) was set at 18 mm.

The coating production line was constituted in the same manner as FIG. 7. However, only one slot nozzle spray apparatus was used, which was arranged in the position (in the falling rate drying section and prior to the drying end point) 200 seconds after the start of the drying process of the aforesaid porous ink absorptive layer.

As coating conditions, overcoating was carried out at a coating speed of 150 m/minute to achieve a wet layer thickness of 15 μm. The liquid coating composition, which fell on the substrate, was in the form of droplets. The resulting uniformity of droplets across the coating width was as follows.

| | |
|---|---|
| Variation of average droplet diameter | ±6.7 percent |
| Variation of length of drop | ±3.6 percent |
| Variation of spreading angle | ±3.3 percent |
| Variation of space density | ±4.0 percent |

(Coating Method 2)

Coating Method 2 was carried out in the same manner as aforesaid Coating Method 1, except that the slot nozzle spray apparatus was arranged at a position (at and after the drying end point) 300 seconds at and after the start of the drying process. The state of the liquid coating composition, which fell on the substrate, was the same as Coating Method 1 of the present invention.

(Coating Method 3)

Coating Method 3 was practiced in the same manner as the aforesaid Coating method 1, except that two slot nozzle spray apparatuses were used in stead of one, and one was arranged in the position of 200 seconds at and after the start of the drying process and the other was arranged in the position of 300 seconds at and after the same. Each state of the liquid coating composition, which fell on the substrate, was the same as Coating Method 1.

(Coating Method 4)

Coating Method 4 was carried out in the same manner as aforesaid Coating Method 1, except that the size of each opening end of the liquid coating composition nozzle of the slot nozzle spray apparatus was changed to 300 μm rectangular; the pitch was changed to 3,000 μm; the inner gas pressure was changed to 8 kPa, and the air flow rate was changed to 7 CMM/m. Due to these changes, the state of the liquid coating composition, which fell on the substrate, was set as described below.

| | |
|---|---|
| Variation of average droplet diameter | ±24 percent |
| Variation of length of drop | ±13 percent |
| Variation of spreading angle | ±12 percent |
| Variation of space density | ±15 percent |

(Coating Method 5)

In the aforesaid Coating Method 1, the following were changed.

The added amount of polyvinyl alcohol (having an average degree of polymerization of 3,800 and a saponification ratio of 88 percent) in the composition of a boric acid solution, employed as an overcoating layer coating composition, was regulated to increase viscosity. In such a case, the viscosity of the liquid coating composition was 300 mPa·s, and the surface tension was 40 mN/m. Further, during the operation, the inner gas pressure and the air flow rate were set at 20 kPa and 12 CCM/m, respectively. The state of the liquid coating composition, which fell onto the substrate, was in the form of threads.

(Coating Method 6)

Coating Method 6 was carried out in the same manner as the aforesaid Coating Method 6, except that the slot nozzle spray apparatus was replaced with an extrusion coating apparatus. In such a case, the liquid coating composition was in the form of a bead-shaped liquid layer from the coating apparatus to the substrate.

Each of the ink jet recording media prepared by each of the aforesaid coating methods was evaluated as described below. Table 1 shows the results.

(Evaluation of Coatability)

The surface of each recording medium, which had been subjected to complete coating and drying, was visually inspected and coatability was evaluated based on the criteria described below.

A: no coating unevenness was noticed on the coating surface;

B: minute coating unevenness was slightly noticed on the coating surface;

C: coating unevenness was slightly noticed on the coating surface, but was in a commercially viable range;

D: marked coating unevenness was noticed on the coating surface and was in a commercially unviable range; and

E: excessive coating unevenness was noticed on the coating surface.

(Evaluation of Drying Properties)

The surface of each recording medium, which had been subjected to complete coating and drying, was visually inspected and drying properties were evaluated based on the criteria described below.

TABLE 1

| | State of | | | |
|---|---|---|---|---|
| | Liquid | | | |
| Coating | Coating | | Drying | |
| Method | Composition | Coatability | Properties | Remarks |
| 1 | droplet | B | B | Present |
| | | | | Invention |
| 2 | droplet | B | A | Present |
| | | | | Invention |
| 3 | droplet | A | A | Present |
| | | | | Invention |
| 4 | droplet | C | B | Present |
| | | | | Invention |
| 5 | thread | E | D | Comparative |
| | | | | Example |
| 6 | bead | E | D | Comparative |
| | | | | Example |

A: the coating surface was completely dried;
B: the coating surface was almost dried;
C: at the edges of the coating surface, portions were noticed which were mostly dried, but were in a commercially viable range;
D: at the edges of the coating surface, portions were noticed which were markedly not dried, and were in a commercially unviable range; and
E: portions which were not completely dried were noticed over the entire coated surface.

### Example 2

In Coating Methods 1 through 6 described in Example 1, coating was carried out in the same manner, except that the 4 percent boric acid solution was replaced with a betaine type surfactant. The resultant coatings exhibited the same trend as Example 1.

### Example 3

In Coating Methods 1 through 6 described in Example 1, coating was carried out in the same manner, except that the 4 percent boric acid solution was replaced with an anti-discoloring agent. The resultant coatings exhibited the same trend as Example 1.

### Example 4

In Coating Methods 1 through 6 described in Example 1, coating was carried out in the same manner, except that the 4 percent boric acid solution was replaced with an aqueous polyvalent metal containing solution. The resultant coatings exhibited the same trend as Example 1.

### Example 5

Coating methods, in which only the wet layer thickness in Coating Method 5 (thread coating) and Coating Method 6 (extrusion coating) was changed to 60 μm, were designated as Coating Methods 7 and 8, respectively. In Coating Method 7, coatability was raised to evaluation D, while drying properties lowered to evaluation E.

### Example 6

Coating methods, in which only the coating speed in Coating Methods 1 through 6 was changed from 150 m/minute to 300 m/minute, were designated as Coating Methods 9 through 14. Coating Methods 9 through 12 exhibited approximately the same results as Coating Methods 1 through 4. However, Coating Methods 13 and 14 resulted in greater degradation of coated properties.

### Example 7

A coating method was designated as Coating Method 21 in which in Coating Method 1 of Example 1, the inner gas pressure and the air flow velocity were changed to 20 kPa and 12 CMM/m, respectively. In such a case, the average diameter of liquid droplets was 20 μm. Coating Methods 22 and 23 were carried out in such a manner that the pressure, the air flow velocity, and the average diameter of droplets of liquid coating compositions were regulated as shown in the Table 2 below. The Table 2 shows the results.

As can be seen from the Table 2, when the pressure is at least 10 kPa, coatability and drying properties, which are the purposes of the present invention are acceptable. Further, when the pressure is at most 100 kPa, the coating yield is further enhanced. It is assumed that when the pressure is not excessively high but is in the optimal range, the ratio of droplets of the liquid coating composition, which are blown off by air, decreases, whereby it is possible to carry out coating, resulting in an enhanced yield.

TABLE 2

| | | | Average | | | |
|---|---|---|---|---|---|---|
| | | Air flow | Droplet | | | |
| | Pressure | velocity | Diameter | Yield | Coat- | Drying |
| | (kPa) | (m/s) | (μm) | (%) | ability | Properties |
| Coating | 50 | 283 | 20 | 90 | A | A |
| Method | | | | | | |
| 21 | | | | | | |
| Coating | 90 | 380 | 12 | 90 | A | A |
| Method | | | | | | |
| 22 | | | | | | |
| Coating | 120 | 438 | 8 | 80 | A | A |
| Method | | | | | | |
| 23 | | | | | | |

According to the present invention, it is possible to provide a coating method which results in high speed coating of a thin layer and desired drying properties, and coated products as well as ink jet recording media using the same.

What is claimed is:

1. A coating method comprising the steps of:
(a) forming liquid droplets of a liquid coating composition across a coating width in a direction perpendicular to a conveyance direction of a substrate to be coated; and
(b) spraying the liquid droplets formed toward the substrate while conveying the substrate, thereby coating the liquid coating composition onto the substrate.

2. The coating method of claim 1, wherein variation of an average diameter of the liquid droplets sprayed onto the substrate across the coating width is less than or equal to ±20 percent.

3. The coating method of claim 1, wherein variation of an area range of a liquid droplet which is fallen onto the substrate across the coating width of a length in the conveyance direction is less than or equal to ±10 percent.

4. The coating method of claim 1, wherein variation of a spread angle of a liquid droplet which is fallen onto the substrate across the coating width is less than or equal to ±10 percent.

5. The coating method of claim 1, wherein variation of a space density of a group of liquid droplets which fall on the substrate across the coating width is less than or equal to ±10 percent.

6. The coating method of claim 1, wherein the forming step comprises forming the liquid droplets while making gas to collide with the liquid coating composition, by employing a slot nozzle spray apparatus which includes a plurality of liquid coating composition nozzles, which discharge the liquid coating composition across the coating width, and gas nozzles each ejecting the gas, which is provided adjacent to an opening end of the liquid coating composition nozzles, thereby the spraying step is performed.

7. The coating method of claim 6, wherein a plurality of the slot nozzle spray apparatus are provided in the conveyance direction of the substrate and the step of spraying the liquid droplets of the liquid coating composition is carried out at multiple stages.

8. The coating method of claim 6, wherein viscosity of the liquid coating composition is from 0.1 to 250 mPa·s.

9. The coating method of claim 8, wherein viscosity of the liquid coating composition is from 0.1 to 50 mPa·s.

10. The coating method of claim 9, wherein viscosity of the liquid coating composition is from 0.1 to 20 mPa·s.

11. The coating method of claim 1, wherein the liquid coating composition comprises a solvent which is water or a mixed solution comprising a water-compatible organic solvent and water.

12. The coating method of claim 1, wherein a wet layer thickness of the liquid coating composition is from 1 to 50 μm.

13. The coating method of claim 1, wherein a coating speed of a coating layer is from 50 to 300 m/minute.

14. The coating method of claim 1, wherein the substrate includes a support having thereon at least one composition layer.

15. The coating method of claim 14, wherein the spraying step is carried out onto the composition layer during and after decreasing drying rate period of the composition layer after the composition layer has been applied onto the support.

16. The coating method of claim 15, wherein the spraying step is carried out onto the composition layer at and after the drying end point of the composition layer after the composition layer has been applied onto the support.

17. The coating method of claim 15, wherein the liquid coating composition includes a functional compound for the composition layer.

18. The coating method of claim 17, wherein the liquid coating composition is an uppermost layer coating composition for a ink jet recording sheet.

19. The coating method of claim 18, wherein the composition layer is an ink absorptive layer.

20. The coating method of claim 17, wherein the functional compound is selected from any one of a surfactant, a hydrophilic binder cross-linking agent, an image stabilizer, and a water-soluble polyvalent metal compound.

21. The coating method of claim 20, wherein the liquid coating composition comprises a solvent which is water or a mixed solution comprising a water-compatible organic solvent and water.

22. The coating method of claim 14, wherein the support is a support which is prepared by covering both sides of sheet with a polyolefin resin.

23. The coating method of claim 6, wherein the following condition is satisfied:
126 m/s<v<400 m/s
where v represents a linear air flow velocity immediately after an exit of the gas nozzle.

24. The coating method of claim 2, wherein the following condition is satisfied:
10 μm<D<70 μm
where D represents an average diameter of the liquid droplets of the liquid coating composition.

25. The coating method of claim 1, wherein the following condition is satisfied:
15×pitch<G<20×pitch
where the pitch represents an interval between adjacent openings of the liquid coating composition nozzles or the gas nozzles, and G represents a distance between a liquid coating composition discharge section and the substrate.

26. A coating product which is produced while employing the coating method described in any one of claims 1 through 17.

27. An ink jet recording medium which is produced while employing the coating method described in any one of claims 1 through 25.
